(19) United States
(12) Patent Application Publication
(10) Pub. No.: US 2016/0047973 A1
(43) Pub. Date: Feb. 18, 2016

(54) LIGHT GUIDE PLATE, AND BACKLIGHT UNIT AND DISPLAY DEVICE INCLUDING THE SAME

(71) Applicant: New Optics, Ltd, Yangju-si (KR)

(72) Inventors: Dong-Yong KIM, Cheonan-si (KR); Jong-Moon YOON, Yangju-si (KR); Min-Kyoung PARK, Seoul (KR)

(21) Appl. No.: 14/828,712

(22) Filed: Aug. 18, 2015

Related U.S. Application Data
(60) Provisional application No. 62/038,723, filed on Aug. 18, 2014.

(30) Foreign Application Priority Data
Mar. 31, 2015 (KR) 10-2015-0045741

(51) Int. Cl. F21V 8/00

(52) U.S. Cl. CPC G02B 6/0045; G02B 6/0055

(57) ABSTRACT

Provided are a light guide plate, and a backlight unit and a display device including the same. The light guide plate includes a light output surface configured to output light to the outside; a reflective surface positioned opposite the light output surface; a light incident surface provided on at least one side surface of side surfaces which connect the light output surface and the reflective surface, and configured to receive light emitted from a light source; and a plurality of reflection patterns provided on the reflective surface.

### RELATED APPLICATIONS

This application claims the benefit of priority of both U.S. Provisional Patent Application No. 62/038,723 filed on Aug. 18, 2014, and Korean Patent Application No. 10-2015-0045741 filed on Mar. 31, 2015. The contents of the above applications are all incorporated by reference as if fully set forth herein in their entirety.

### FIELD AND BACKGROUND OF THE INVENTION

Related to a light guide plate, a backlight unit and a display device including the same, and more particularly, a light guide plate capable of improving a light diffusion degree, and a backlight unit and a display device including the same.

As a backlight unit (BLU) is one type of light source device which supplies light to the rear surface of a screen of each liquid crystal display LCD device, the BLU influences image qualities, such as the luminance of an image, color reproducibility, a viewing angle, a contrast range, legibility, etc., power consumption, a product lifetime, etc., and is a core component which accounts for approximately 20 to 50% of an overall cost of the LCD device.

The BLU is largely classified as a direct-lit type and an edge-lit type according to an arrangement position of a light source. The direct-lit type uses light projected from the light source disposed in the direct rear of a screen light and moved in a direction of a liquid crystal panel, but the edge-lit type supplies light to a display panel by guiding light projected from a light source disposed on an edge of a screen in a side direction to a liquid crystal panel using a light guide plate. Due to structural differences between the direct-lit type and the edge-lit type, the direct-lit type has advantages for luminance, a contrast range, screen uniformity, image reproducibility, etc., and the edge-lit type has advantages for a product thickness and costs.

Recently, edge-lit type backlights having an advantage of a product exterior have been increasingly important in the display industry because a display product becomes more important for the value of an indoor interior decoration. Particularly, the trend of consumer demands for ultra-thin display products is increasing and studies for reducing diffusion sheets, about 3 to 5 diffusion sheets disposed in the rear of a display panel, are actively conducted as much as possible according to the trend. This type of display product has problems that a light diffusion degree thereof is difficult to secure as much as that of existing diffusion sheets and a hot spot is issued due to the light diffusion degree. Therefore, the development of a light guide plate capable of improving the light diffusion degree is emerging as a key technology.

### SUMMARY OF THE INVENTION

Provide a light guide plate capable of improving a light diffusion degree, and a backlight unit and a display device including the same.

One aspect of the present invention provides a light guide plate including: a light output surface configured to output light to the outside; a reflective surface positioned opposite the light output surface; a light incident surface provided on at least one side surface of side surfaces which connect the light output surface and the reflective surface, and configured to receive light emitted from a light source; and a plurality of reflection patterns provided on the reflective surface, wherein the reflection pattern includes a concave portion recessed in the reflective surface, wherein the concave portion includes a first inclined surface which is formed to have a slope from the reflective surface toward the light output surface and has an edge which is in contact with the reflective surface and is formed in a curved line, and a second inclined surface which is formed to have a slope from the first inclined surface toward the reflective surface and has an edge which is in contact with the reflective surface and formed in a curved line.

Further, another aspect of the present invention provides a back light unit including: a light source configured to emit light; and a light guide plate, wherein the light guide plate includes a light incident surface which faces the light source and receives incident light emitted from the light source, a light output surface which is perpendicular to the light incident surface and configured to output incident light to an outside, a reflective surface which is a surface opposite the light output surface, and a plurality of reflection patterns provided on the reflective surface to be parallel to the light incident surface, wherein each of the reflection patterns includes a concave portion recessed in the reflective surface, wherein the concave portion includes a first inclined surface which is formed to have a slope from the reflective surface toward the light output surface and has an edge which is in contact with the reflective surface and formed in a curved line, and a second inclined surface which is formed to have a slope from the first inclined surface toward the reflective surface, and has an edge which is in contact with the reflective surface and formed in a curved line.

According to the embodiment of the present invention, light is scattered by reflection patterns, and thus a degree of scattering or diffusion of light output from a light guide plate can be improved.

Further, according to the embodiment of the present invention, since a light guide plate capable of improving the degree of scattering is used, a hot spot can be improved.

### BRIEF DESCRIPTION OF THE SEVERAL VIEWS OF THE DRAWINGS

FIG. 1 is an exploded perspective view of a display device according to one embodiment of the present invention.

FIG. 2 is a cross-sectional view of the display device according to one embodiment of the present invention.

FIG. 3 is a perspective view of a light guide plate according to one embodiment of the present invention.

FIG. 4 is a rear view of the light guide plate in which the density of reflection patterns according to one embodiment of the present invention is uniform.

FIG. 5 is a rear view of the light guide plate in which the density of the reflection patterns according to one embodiment of the present invention is nonuniform.

FIG. 6 is a cross-sectional view of the light guide plate according to one embodiment of the present invention.

FIG. 7 is a perspective view of the light guide plate of which a light incident surface according to one embodiment of the present invention has a pattern.

FIG. 8 is a perspective view of the light guide plate of which a light output surface according to one embodiment of the present invention has a pattern.

FIG. 9 is a perspective view of a first sample of a reflection pattern according to one embodiment of the present invention.

FIG. 10 is a plan view of the first sample of the reflection pattern according to one embodiment of the present invention.

FIG. 11 is a cross-sectional view of the first sample of the reflection pattern according to one embodiment of the present invention.

FIG. 12 is a perspective view of a second sample of a reflection pattern according to one embodiment of the present invention.

FIG. 13 is a plan view of the second sample of the reflection pattern according to one embodiment of the present invention.

FIG. 14 is a cross-sectional view of the second sample of the reflection pattern according to one embodiment of the present invention.

FIG. 15 is a perspective view of a third sample of a reflection pattern according to one embodiment of the present invention.

FIG. 16 is a plan view of the third sample of the reflection pattern according to one embodiment of the present invention.

FIG. 17 is a cross-sectional view of the third sample of the reflection pattern according to one embodiment of the present invention.

FIG. 18 is a perspective view of a fourth sample of a reflection pattern according to one embodiment of the present invention.

FIG. 19 is a plan view of the fourth sample of the reflection pattern according to one embodiment of the present invention.

FIG. 20 is a cross-sectional view of the fourth sample of the reflection pattern according to one embodiment of the present invention.

FIG. 21 is a cross-sectional view of a light guide plate including an asymmetrical reflection pattern according to one embodiment of the present invention.

FIG. 22 is a perspective view of a fifth example of a reflection pattern according to one embodiment of the present invention.

FIG. 23 is a plan view of the fifth example of the reflection pattern according to one embodiment of the present invention.

FIG. 24 is a cross-sectional view of the fifth example of the reflection pattern according to one embodiment of the present invention.

### DESCRIPTION OF SPECIFIC EMBODIMENTS OF THE INVENTION

Hereinafter, a light guide plate according to one embodiment of the present invention, and a backlight unit and a display device including the same will be described with reference to accompanying drawings in detail.

Further, the same or corresponding components may be assigned with the same or similar reference numerals regardless of drawing numerals and the repetitive description thereof will be omitted. The size and shape of each component shown may be exaggerated or reduced for the sake of convenience of the description.

One aspect of the present invention provides a light guide plate including: a light output surface configured to output light to the outside; a reflective surface positioned opposite the light output surface; a light incident surface provided on at least one side surface of side surfaces which connect the light output surface and the reflective surface, and configured to receive light emitted from a light source; and a plurality of reflection patterns provided on the reflective surface, wherein the reflection pattern includes a concave portion recessed in the reflective surface, wherein the concave portion includes a first inclined surface which is formed to have a slope from the reflective surface toward the light output surface and has an edge which is in contact with the reflective surface and is formed in a curved line, and a second inclined surface which is formed to have a slope from the first inclined surface toward the reflective surface and has an edge which is in contact with the reflective surface and formed in a curved line.

When viewed in a direction perpendicular to the reflective surface, the reflection pattern may have a rectangular shape, and the edges of the first inclined surface and the second inclined surface may have curved line shapes protruding to an outside of the rectangular shape.

A curvature of the edge of the first inclined surface and a curvature of the edge of the second inclined surface may be different.

One of the first and second inclined surfaces which is closer to the light incident surface has an edge having a greater curvature than the other.

One of the first and second inclined surfaces which has the greater curvature has a smaller slope angle than the other.

The one having the smaller slope angle between the first inclined surface and the second inclined surface is disposed closer to the light incident surface than the other.

The one having the smaller slope angle between the first and second inclined surfaces has a slope angle in a range of 40 to 60°, and the other having the greater slope angle among the first and second inclined surfaces has a slope angle in a range of 50 to 75°.

The reflection pattern further includes a pair of side surfaces recessed from the reflective surface and formed on both sides of each of the first inclined surface and the second inclined surface, and an edge at which each of the side surfaces and the reflective surface are in contact with each other has a straight line shape.

The reflection pattern further includes a pair of side surfaces formed on both sides of each of the first inclined surface and the second inclined surface and having slopes from the reflective surface toward the light output surface, and an edge at which each of the side surfaces and the reflective surface are in contact with each other has a curved line shape.

A curvature of the edge at which the side surface and the reflective surface are in contact with each other is smaller than those of the edge at which the first inclined surface and the reflective surface are in contact with each other and the edge at which the second inclined surface and the reflective surface are in contact each other.

The reflection pattern may further include a first embossed portion which is formed on an edge of the first inclined surface and protrudes from the reflective surface.

The reflection pattern may further include a second embossed portion which is formed on an edge of the second inclined surface and protrudes from the reflective surface.

A maximum height of the first embossed portion may be greater than that of the second embossed portion, and when viewed in a direction perpendicular to the reflective surface, an area of the first embossed portion may be greater than that of the second embossed portion.

Another aspect of the present invention provides a back light unit including: a light source configured to emit light; and a light guide plate, wherein the light guide plate includes a light incident surface which faces the light source and receives incident light emitted from the light source, a light output surface which is perpendicular to the light incident surface and configured to output incident light to the outside, a reflective surface which is a surface opposite the light output surface, and a plurality of reflection patterns provided on the reflective surface to be parallel to the light incident surface, wherein each of the reflection patterns includes a concave portion recessed in the reflective surface, wherein the concave portion includes a first inclined surface which is formed to have a slope from the reflective surface toward the light output surface and has an edge which is in contact with the reflective surface and formed in a curved line, and a second inclined surface which is formed to have a slope from the first inclined surface toward the reflective surface, and has an edge which is in contact with the reflective surface and formed in a curved line.

When viewed in a direction perpendicular to the reflective surface, the reflection pattern may have a rectangular shape, and edges of the first inclined surface and the second inclined surface have curved line shapes protruding to an outside of the rectangular shape.

A curvature of the first inclined surface and a curvature of the second inclined surface may be different.

An edge of one of the first and second inclined surfaces which is closer to the light incident surface has a greater curvature than the other.

The one having the greater curvature between the first inclined surface and the second inclined surface has a smaller slope angle than the other.

The one having the smaller slope angle between the first inclined surface and the second inclined surface is disposed closer to the light incident surface.

The reflection pattern further may include a first embossed portion which is formed on an edge of the first inclined surface and protrudes from the reflective surface, and a second embossed portion which is formed on an edge of the second inclined surface and protrudes from the reflective surface.

Hereinafter, a display device 1000 according to one embodiment of the present invention will be described. Here, the display device 1000 should be interpreted as a concept including all of various display devices 1000 which output images in addition to liquid crystal display (LCD) devices, plasma display panel (PDP) display devices, and organic light-emitting diode (OLED) display devices. However, it will be described based on the LCD device 1000 for the sake of convenience of the description below.

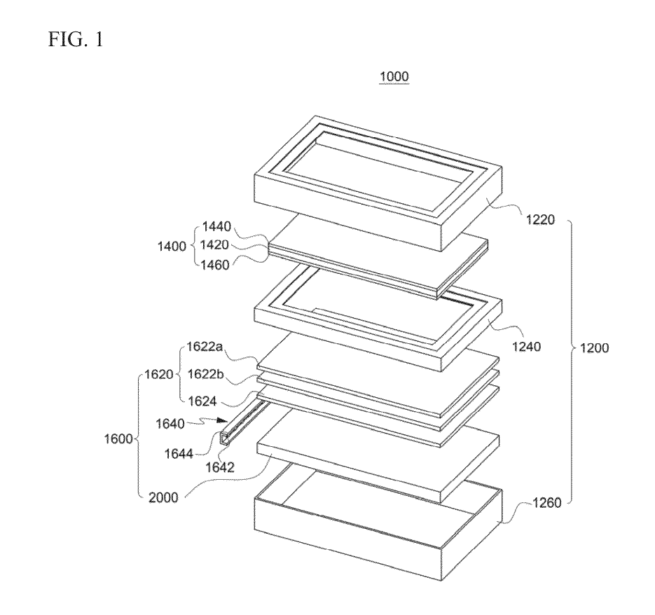

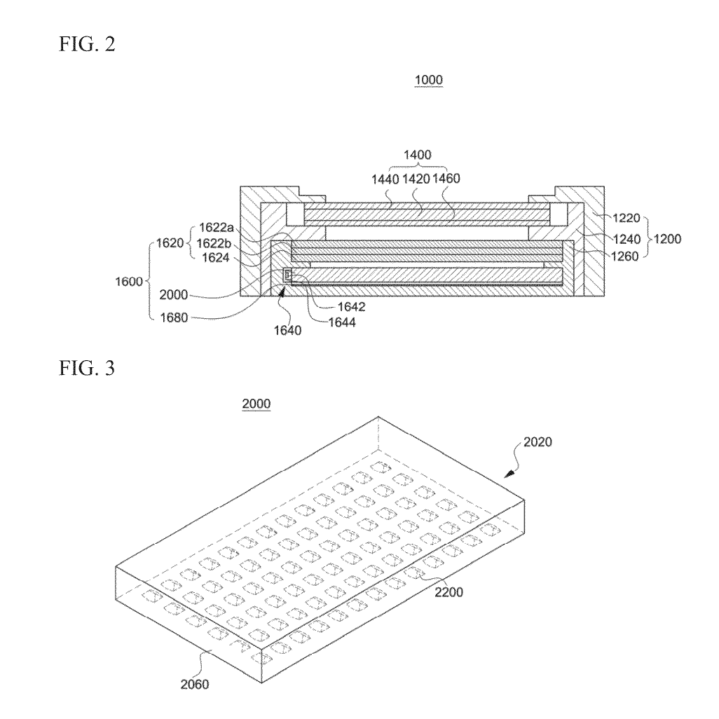

FIG. 1 is an exploded perspective view of the display device 1000 according to one embodiment of the present invention, and FIG. 2 is a cross-sectional view of the display device 1000 according to one embodiment of the present invention.

Referring to FIGS. 1 and 2, the display device 1000 may include a housing 1200, a display panel 1400, and a backlight unit 1600.

The housing 1200 accommodates the display panel 1400 and the backlight unit 1600 therein to protect from an external impact. Further, the housing 1200 serves to connect the display panel 1400 and the backlight unit 1600.

The housing 1200 may include a top case 1220, a guide frame 1240, and a bottom cover 1260. The top case 1220 and the bottom cover 1260 are coupled to respectively cover a front surface and a rear surface of the display device 1000, and the guide frame 1240 is mounted therebetween. The guide frame 1240 may fix the display panel 1400 with a bezel of the top case 1220 and may also fix a light guide plate 2000 and optical sheets 1620 with the bottom cover 1260.

The display panel 1400 displays an image using light supplied from the backlight unit 1600.

The display panel 1400 may include two transparent substrates and a liquid crystal layer 1420 interposed between the transparent substrates. Here, each of the transparent substrate may be a color filter substrate 1460 or a thin film transistor (TFT) substrate 1440. When an electrical signal is applied to the liquid crystal layer 1420 through a gate line and a data line of the TFT substrate 1440, the orientation of liquid crystals is changed, the liquid crystals selectively pass light projected from the backlight unit 1600 by pixel units, and the passed light is changed to color light by the color filter substrate 1460 to output an image. Here, the TFT substrate 1440 may be electrically connected to a panel driver (not shown), such as a chip-on-film (COF) or a tape carrier package (TCP), through a printed circuit board (PCB) (not shown) and may receive a control signal.

The backlight unit 1600 supplies light to the rear of the display panel 1400 so that the display panel 1400 outputs an image.

The backlight unit 1600 may include an optical sheet 1620, a light source array 1640, a light guide plate 2000, and a reflective plate 1680.

The light source array 1640 may include a light source 1642 for generating light and a light source substrate 1644 on which the light source 1642 is installed. The light source 1642 may include a cold cathode fluorescent lamp (CCFL), an external electrode fluorescent lamp (EEFL), a light emitting diode (LED), etc. In the case of an edge-lit type backlight unit 1600, in order to project light to a side surface of the light guide plate 2000, the light source array 1640 may be installed on an edge of the display device 1000 so that light of the light source 1642 is projected in a side direction of the light guide plate 2000. In the case of a direct-lit type backlight unit 1600, the light source 1642 may be installed on the bottom cover 1260 to output light to the rear of the display panel 1400, and at this time, the light source substrate 1644 may be installed on the bottom cover 1260, or the light source substrate 1644 may be removed and the light source 1642 may be directly installed on the bottom cover 1260.

The light guide plate 2000 may be disposed to face a rear surface of the display panel 1400, in the edge-lit type backlight unit 1600. The light guide plate 2000 serves to guide light output in a side direction from the light source 1642 toward the display panel 1400. Further, patterns may each be formed on an upper surface, a lower surface, and a side surface of the light guide plate 2000, the side surface beside the light source 1642, to improve the uniformity of light such as improving luminance, hot spots, etc. Further, a material including poly methyl methacrylate (PMMA), methyl styrene (MS), methyl methacrylate (MMA), glass, or the like may be used for the material of the light guide plate 2000. The detailed description for the light guide plate 2000 will be described below. Meanwhile, in the case of the direct-lit type backlight unit 1600, a diffusion plate which diffuses light may be provided instead of the light guide plate 2000 which guides light.

The optical sheet 1620 is disposed to face the display panel 1400 in the rear of the display panel 1400, and when there is a light guide plate 2000, the optical sheet 1620 may be disposed between the display panel 1400 and the light guide plate 2000. An example of the optical sheet 1620 is a diffusion sheet 1624 or prism sheet 1622. The diffusion sheet 1624 improves the uniformity of light output dispersion because light output from the light guide plate 2000 or diffusion plate is evenly diffused, and the occurrence of a dark/bright pattern, such as a moire phenomenon, or hot spots may be reduced or removed. The prism sheet 1622 may adjust a path of light in a direction perpendicular to the display panel 1400. Light passed through the light guide plate 2000 or diffusion sheet 1624 disperses and moves in a forward direction and the prism sheet 1622 guides the dispersed light in a direction perpendicular to the display panel 1400, and thus the luminance and viewing angle of the display device 1000 can be improved. For example, as shown in FIGS. 1 and 2, in the optical sheet 1620, a vertical prism sheet 1622a, a horizontal prism sheet 1622b, and the diffusion sheet 1624 may be sequentially disposed from the display panel 1400. The arrangement order in the optical sheet 1620 does not have to be the same as the above-described order. That is, a part of the optical sheet 1620 may be removed or may use a number of sheets (e.g., two or more diffusion sheets 1624) and the order may be suitably changed if needed.

The reflective plate 1680 may be attached to the bottom cover 1260. The reflective plate 1680 may reflect light, which is output from the light source 1642 and moved in a rear direction, to the display panel 1400. Since the reflective plate 1680 reflects the light moved in a direction of a rear surface of the light guide plate 2000 or diffusion plate to the display panel 1400, the loss of light is reduced, and thus the overall luminance of the display is improved.

Hereinafter, the light guide plate 2000 according to one embodiment of the present invention will be described in more detail.

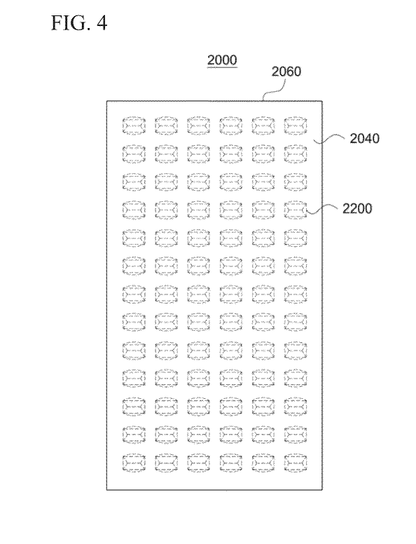

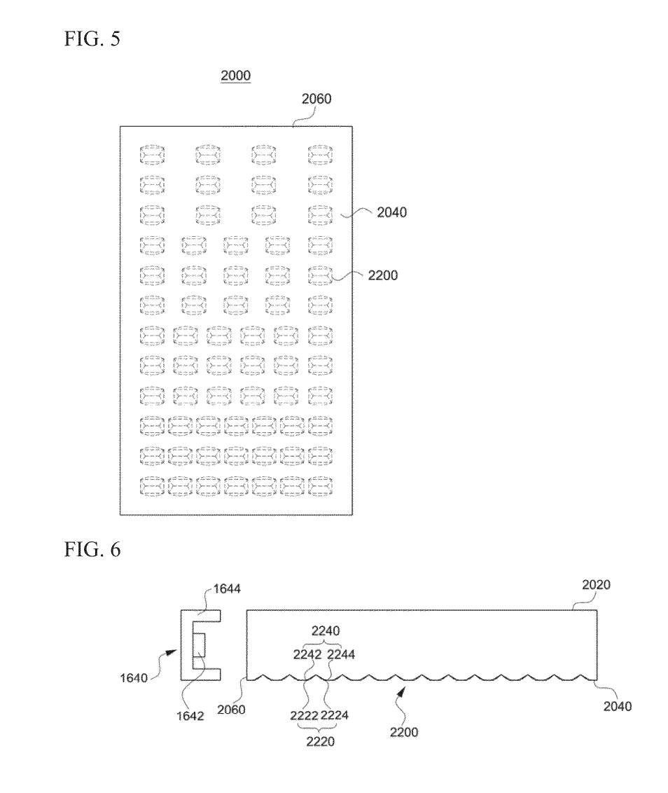

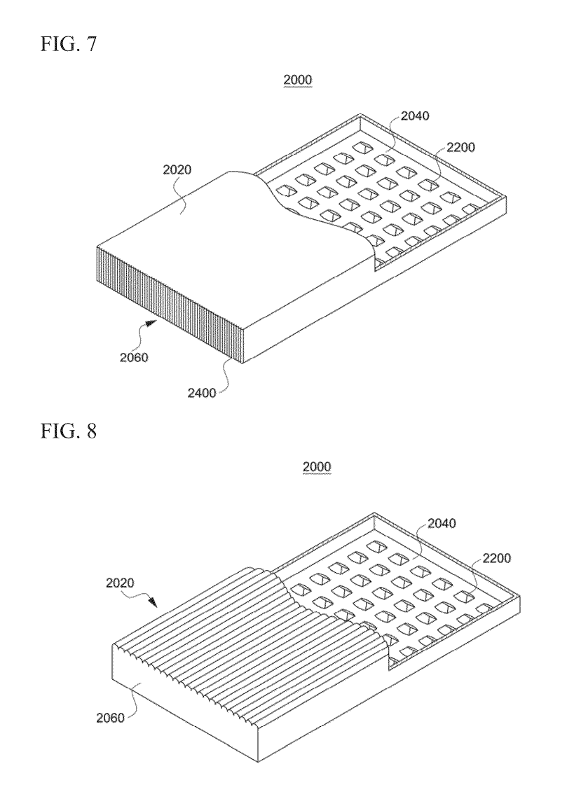

FIG. 3 is a perspective view of the light guide plate 2000 according to one embodiment of the present invention, FIG. 4 is a rear view of the light guide plate 2000 in which the density of reflection patterns 2200 according to one embodiment of the present invention is uniform, FIG. 5 is a rear view of a light guide plate 2000 in which the density of the reflection patterns 2200 according to one embodiment of the present invention is nonuniform, FIG. 6 is a cross-sectional view of the light guide plate 2000 according to one embodiment of the present invention, FIG. 7 is a perspective view of the light guide plate 2000 of which a light incident surface 2060 according to one embodiment of the present invention has a pattern, and FIG. 8 is a perspective view of the light guide plate 2000 of which a light output surface 2020 according to one embodiment of the present invention has a pattern.

Referring to FIGS. 3 to 8, the light guide plate 2000 may be provided in a plate shape. Thus, the light guide plate 2000 may have a pair of primary surfaces and side surfaces which connect the primary surfaces. An upper surface of the pair of primary surfaces close to the display panel 1400 is a light output surface 2020 which outputs light to the display panel 1400, and the opposite surface thereof is a reflective surface 2040 which reflects light. Further, at least one surface of the side surfaces is disposed to face the light source 1642 and is the light incident surface 2060 which receives light. Generally, since the display device 1000 has a tetragonal screen, the light guide plate 2000 may also have a shape of a tetragonal plate corresponding thereto. In the case of the light guide plate 2000 in a shape of a tetragonal plate, any one surface, a pair of vertically facing surfaces, or a pair of laterally facing surfaces of four side surfaces may become the light incident surface 2060. Meanwhile, FIG. 3 illustrates that the light guide plate 2000 is a planar plate of which the thickness is entirely uniform, but the present invention is not limited thereto. For example, in the light guide plate 2000, it is possible that portions around a side surface thereof facing the light source 1642 may be thicker than other portions thereof to improve the efficiency of incident light.

The light guide plate 2000 receives light projected from the light source 1642 through the light incident surface 2060 and the light is guided by the light guide plate 2000 to be output to a face form of the light source 1642 through the light output surface 2020. The reflective surface 2040 serves to reflect light moved to a rear surface of the light guide plate 2000 to the light output surface 2020. Patterns for effectively receiving, guiding, and reflecting light may be respectively formed on the light incident surface 2060, the light output surface 2020, and the reflective surface 2040, and particularly, the reflection pattern 2200 may be formed on the reflective surface 2040 to reflect light moved to the rear surface of the light guide plate 2000, i.e., moved to the reflective surface 2040.

A plurality of reflection patterns 2200 may be formed on the reflective surface 2040. Here, the reflection patterns 2200 may be formed on the reflective surface 2040 with uniform density as shown in FIG. 4 or may be formed with nonuniform density as shown in FIG. 5. Particularly, in the case of a large screen, a difference of luminance between a region close to the light incident surface 2060 of the light guide plate 2000 and a region far therefrom may be generated, but the difference of luminance may be reduced by forming the reflection patterns 2200 on the region far from the light incident surface 2060 more densely than the region close thereto. Here, the density of the reflection patterns 2200 may be defined by a cover rate which means a ratio of the reflection patterns 2200 to the reflective surface 2040, a size of the reflection patterns 2200, an interval of the reflection pattern 2200, etc.

The reflection pattern 2200 may be formed by a silk screening technique, a printing technique, a laser etching technique, a deposition technique, a pressing technique, a roll stamping technique, etc. The reflection pattern 2200 may be formed in a specific form to effectively refract or reflect light moved to the rear surface of the light guide plate 2000 to the light output surface 2020 by the above-described process and detailed descriptions for the formation of the reflection pattern 2200 will be described below.

Meanwhile, a serration pattern 2400 may be formed on the light incident surface 2060 of the light guide plate 2000 to improve a distribution angle of light incident from the light source 1642 and to increase a diffusion effect. The serration pattern 2400 may be formed on the light incident surface 2060 so that an embossed portion and a concave portion extending in a vertical direction as shown in FIG. 7 are repeatedly disposed in a direction of the width of the light incident surface 2060. Further, a light guide pattern 2600 for guiding light incident through the light incident surface 2060 to all regions of the light guide plate 2000 may be formed on the light output surface 2020 of the light guide plate 2000. The light guide pattern 2600 may be repeatedly formed on the light output surface 2020 to extend in a direction perpendicular to the light incident surface 2060, and may have a lenticular pattern form as shown in FIG. 8 or may be formed in a trigonal or tetragonal prism pattern form.

The above-described serration pattern 2400 or light guide pattern 2600 may be provided to the light guide plate 2000 with the reflection pattern 2200, and in some cases, the serration pattern 2400, the light guide pattern 2600, and the reflection pattern 2200 may all be formed on the light guide plate 2000.

Hereinafter, the reflection pattern 2200 according to one embodiment of the present invention will be described.

The reflection pattern 2200 is formed in a specific form by protruding from or recessed in the reflective surface 2040, and thus light moved to the rear surface of the light guide plate 2000 may be reflected. When the light is reflected as described above, an amount of light output through the light output surface 2020 of the light guide plate 2000 is eventually increased, and thus the luminance of the display device 1000 can be increased.

In the embodiment of the present invention, the reflection pattern 2200 may be basically provided in a prism pattern form. The entire reflection pattern 2200 may have a portion recessed from the reflective surface 2040 in a prism shape when viewed in a direction perpendicular to the reflective surface 2040.

The reflection pattern 2200 may be mainly formed by roll stamping or pressing. Specifically, the recessed region may be formed by pressuring the reflective surface 2040 using roll stamping or pressing, and the protruding region may be formed because a material in the recessed region is moved to the vicinity thereof. At this time, roll stamping or pressing using a thermal pressing method can effectively perform the above patterning process.

The reflection pattern 2200 reflects, refracts, or scatters light which is incident from the light incident surface 2060 and moved to the reflective surface 2040, or light which is reflected from the light output surface 2020 and moved to the reflective surface 2040 in each region, and thus light can be effectively reflected.

Specifically, an embossed portion 2260 in the reflection pattern 2200 may first refract, scatter, diffuse, or reflect light, and a concave portion 2220 therein may refract, scatter, diffuse, or reflect the light again. Accordingly, it is advantageous to increase in the luminance uniformity of the entire light output surface 2020.

Hereinafter, a first sample of various forms for the reflection pattern 2200 according to one embodiment of the present invention will be described.

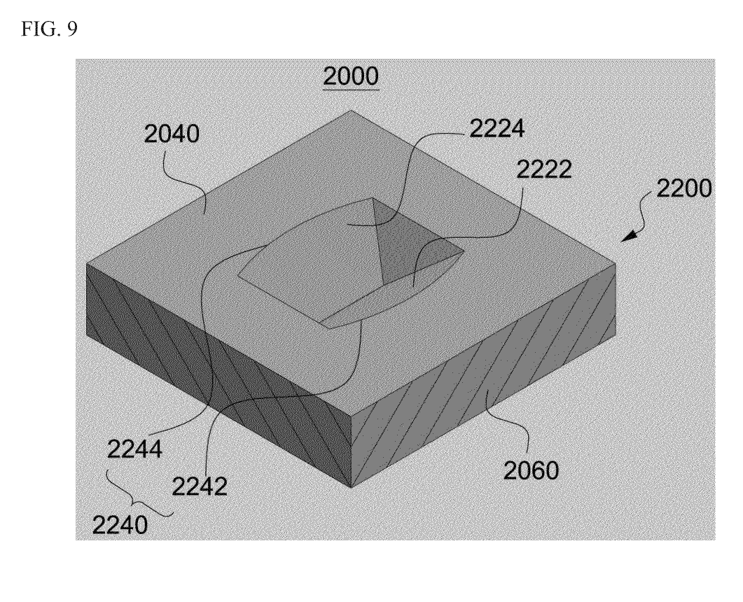

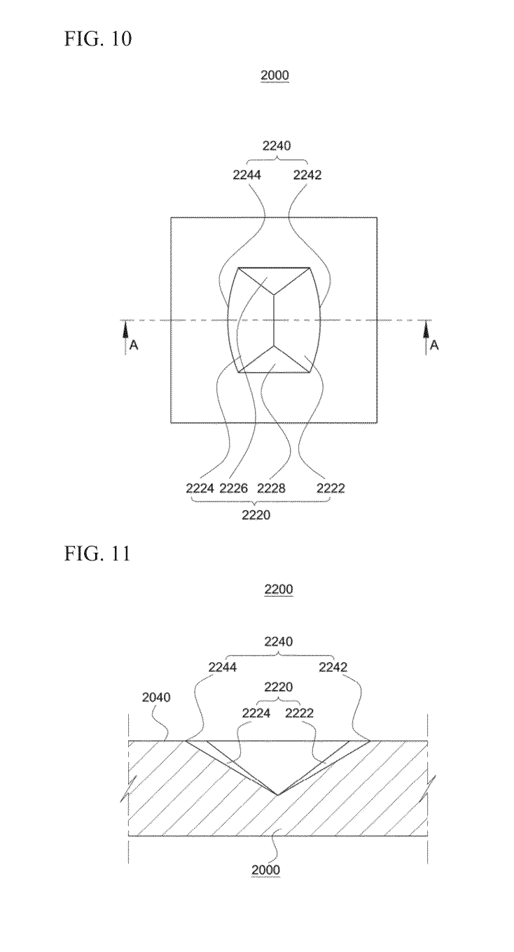

FIG. 9 is a perspective view of the first sample of the reflection pattern 2200 according to one embodiment of the present invention, FIG. 10 is a plan view of the first sample of the reflection pattern 2200 according to one embodiment of the present invention, and FIG. 11 is a cross-sectional view of the first sample of the reflection pattern 2200 according to one embodiment of the present invention.

Referring to FIGS. 9 to 11, a first form of the reflection pattern 2200 according to one embodiment of the present invention may include a concave portion 2220 and a boundary portion 2240 which surrounds the concave portion 2220.

The concave portion 2220 is a portion recessed in the inside of the level of the reflective surface 2040. Here, the concave portion 2220 may include a first inclined surface 2222, a second inclined surface 2224, a third inclined surface 2226 and a fourth inclined surface 2228. Here, the third inclined surface 2226 and fourth inclined surface 2228 corresponds to side surfaces of the concave portion 2220.

In the first form of the reflection pattern 2200, when viewed in a direction perpendicular to the reflective surface 2040, the concave portion 2220 may have a tetragonal shape, and may be provided in a square, rectangular, or isosceles trapezoidal shape (However, it will be described based on the rectangular shape for the sake of convenience of the description below). Edges at which the first inclined surface 2222 and the second inclined surface 2224 are in contact with the reflective surface 2040 may be parallel to the light incident surface 2060. The first inclined surface 2222 may be formed to have a slope from an edge which is in contact with the reflective surface 2040 to the light output surface 2020. Further, the second inclined surface 2224 may be formed to have a slope from an edge which is in contact with the reflective surface 2040 to the light output surface 2020. Further, the end portions of the first inclined surface 2222 and the second inclined surface 2224 may be connected to each other. The third inclined surface 2226 and the fourth inclined surface 2228 may be formed to be recessed from the reflective surface 2040 so that edges thereof are in contact with the first inclined surface 2222, the second inclined surface 2224, and the reflective surface 2040. Thus, the inclined surfaces may each have a three-dimensional prism shape. That is, the concave portion 2220 may have a shape in which the depth thereof increases from the boundary portion 2240 to the center of the concave portion 2220, the third inclined surface 2226 and the fourth inclined surface 2228 may be formed between both ends of the first inclined surface 2222 and the second inclined surface 2224. Here, slope angles of the first inclined surface 2222 and the second inclined surface 2224 may be the same, and slope angles of the third inclined surface 2226 and the fourth inclined surface 2228 may also be the same.

The boundary portion 2240 is a boundary at which the concave portion 2220 and the reflective surface 2040 are in contact with each other in a rectangular, square, or isosceles trapezoidal shape. The boundary portion 2240 may include a first edge 2242 corresponding to a boundary at which the first inclined surface 2222 and the reflective surface 2040 are in contact with each other, and a second edge 2244 corresponding to a boundary at which the second inclined surface 2224 and the reflective surface 2040 are in contact with each other. The first edge 2242 and the second edge 2244 may be formed in a curved line shape protruding to an outside of the concave portion 2220. Accordingly, a distance between the first edge 2242 and the second edge 2244 is the greatest at the center of the concave portion 2220, and is decreased to both end portions of the concave portion 2220. At this time, the curvatures of the first edge 2242 and the second edge 2244 are the same, and as the boundary portion 2240 is bent, the area of the concave portion 2220 may be increased.

Since, in the reflection pattern 2200, the area at which light can arrive is increased, an amount of light scattered and diffused by the reflection pattern 2200 and emitted to the light output surface 2020 can be increased, and thus the luminance uniformity thereof can be greatly improved.

Hereinafter, a second sample of various forms for the reflection pattern 2200 according to one embodiment of the present invention will be described.

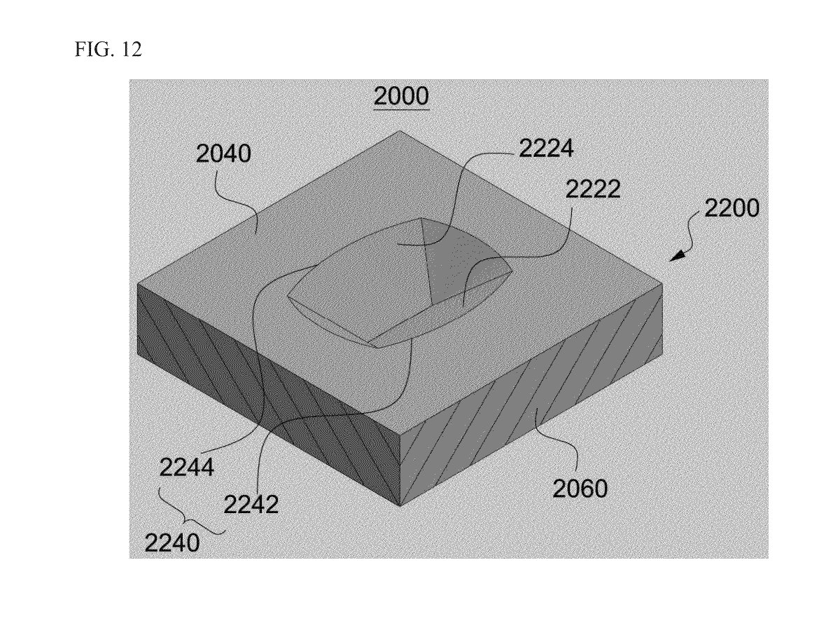

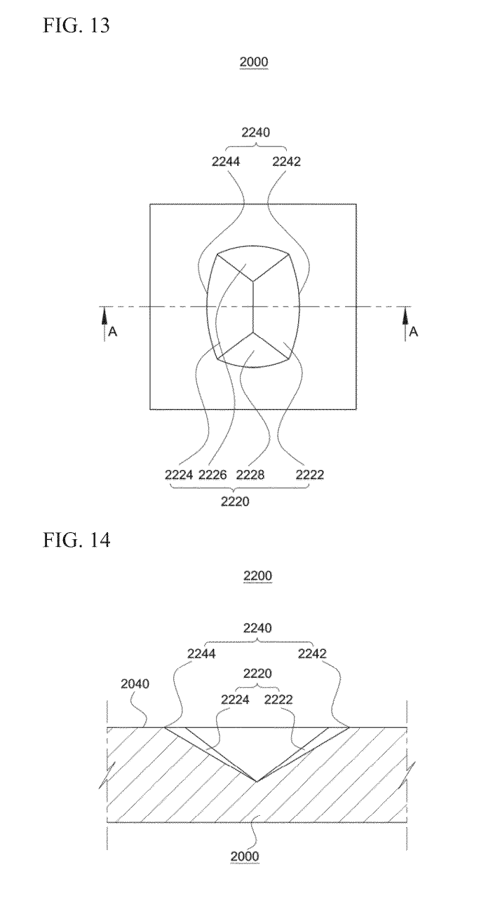

FIG. 12 is a perspective view of the second sample of the reflection pattern 2200 according to one embodiment of the present invention, FIG. 13 is a plan view of the second sample of the reflection pattern 2200 according to one embodiment of the present invention, and FIG. 14 is a cross-sectional view of the second sample of the reflection pattern 2200 according to one embodiment of the present invention.

Referring to FIGS. 12 to 14, a second form of the reflection pattern 2200 according to one embodiment of the present invention may include a concave portion 2220, a boundary portion 2240 which surrounds the concave portion 2220.

However, the boundary portion 2240 may include the first edge 2242 corresponding to the boundary in which the first inclined surface 2222 and the reflective surface 2040 are in contact with each other and the second edge 2244 corresponding to the boundary in which the second inclined surface 2224 and the reflective surface 2040 in the first form, the boundary portion 2240 may include a third edge 2246 corresponding to a boundary in which a third inclined surface 2226 and the reflective surface 2040 are in contact with each other and a fourth edge 2248 corresponding to a boundary in which a fourth inclined surface 2228 and the reflective surface 2040 in the second form.

Since, in the reflection pattern 2200 having the second form, the shape of the concave portion 2220 may be entirely similar to the shape of the concave portion 2220 in the first form of the reflection pattern 2200, the descriptions thereof will be omitted.

In the reflection pattern 2200 having the second form, the boundary portion 2240 may include a third edge 2246 and a fourth edge 2248 corresponding to a boundary at which the third inclined surface 2226 and the fourth inclined surface 2228 are in contact with the reflective surface 2040. The third edge 2246 and the fourth edge 2248 may be formed in curved line shapes protruding to an outside of the concave portion 2220, and a distance between the third edge 2246 and the fourth edge 2248 may be the greatest at the center of the concave portion 2220, and is decreased to both end portions of the concave portion 2220. At this time, the curvatures of the third edge 2246 and the fourth edge 2248 may be the same, or different. Further, the curvatures of the third edge 2246 and the fourth edge 2248 may be smaller than those of the first edge 2222 and the second edge 2224.

Since the reflection pattern 2200 having the second form includes the third edge 2246 and the fourth edge 2248 bent compared to the reflection pattern 2200 having the first form, an area at which incident light arrives may be increased.

Accordingly, an amount of light scattered and diffused by the reflection pattern 2200 and emitted to the light output surface 2020 may be increased, and thus the luminance uniformity thereof can be greatly improved.

Hereinafter, a third sample of various forms for the reflection pattern 2200 according to one embodiment of the present invention will be described.

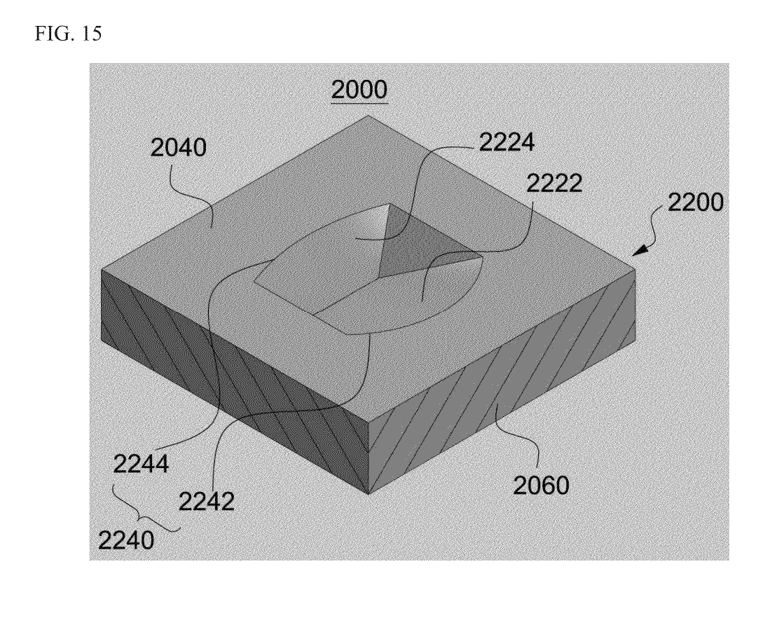

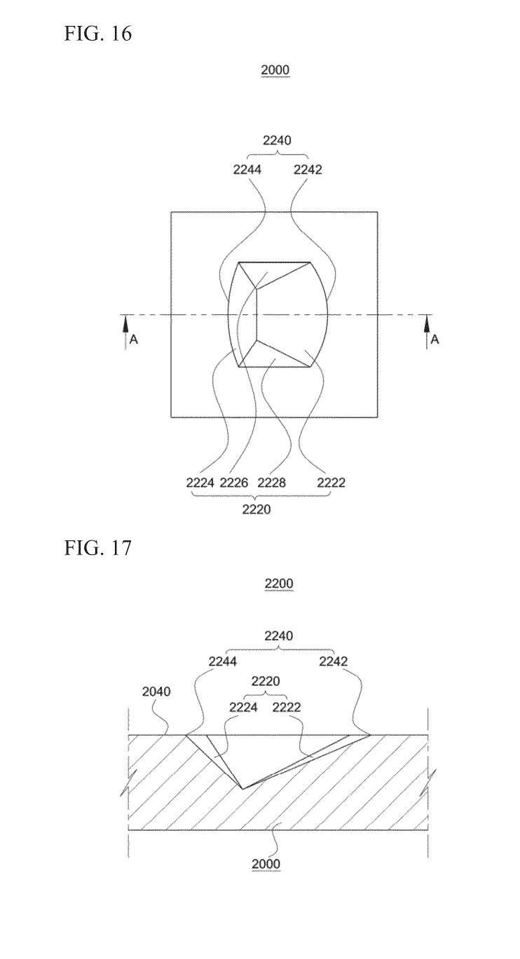

FIG. 15 is a perspective view of the third sample of the reflection pattern 2200 according to one embodiment of the present invention, FIG. 16 is a plan view of the third sample of the reflection pattern 2200 according to one embodiment of the present invention, and FIG. 17 is a cross-sectional view of the third sample of the reflection pattern 2200 according to one embodiment of the present invention.

Referring to FIGS. 15 to 17, a third form of the reflection pattern 2200 according to one embodiment of the present invention may include a concave portion 2220, and a boundary portion 2240 which surrounds the concave portion 2220. However, the slope angles of the first inclined surface 2222 and the second inclined surface 2224 in the concave portion 2220 may be the same and the curvatures of the first edge 2242 and the second edge 2244 may be the same in the first form, but the slope angles of a first inclined surface 2222 and a second inclined surface 2224 in the concave portion 2220 may be different and the curvatures of a first edge 2242 and a second edge 2244 may be different in the third form.

In the reflection pattern 2200 having the third form, the curvatures of the first edge 2242 and the second edge 2244 in the boundary portion 2240 may be different. For example, the curvature of the first edge 2242 may be greater than that of the second edge 2244.

In the reflection pattern 2200 having the third form, the slope angles of the first inclined surface 2222 and the second inclined surface 2224 in the concave portion 2220 may be different. For example, the slope angle of the first inclined surface 2222 may be smaller than that of the second inclined surface 2224. At this time, the first inclined surface 2222 may have a gently inclined surface, and may be formed at a side closer to the light incident surface 2060. When the gently inclined surface is positioned closer to the light incident surface 2060, light incident from the light incident surface 2060 may be refracted and reflected to the light output surface 2020 from a wide range. At this time, a curvature of an edge of an inclined surface having a smaller slope angle may be greater than that of edge of an inclined surface having a greater slope angle. However, a relation between the size of a slope angle and the curvature of an edge may not need to have the relation described above, but, it is possible that a curvature of an edge of an inclined surface having a greater slope angle is smaller than that of an edge of an inclined surface having a smaller slope angle. Meanwhile, it is possible that an inclined surface having a greater slope angle is disposed on a side closer to the light incident surface 2060 if needed.

Since the shape of the reflection pattern 2200 having the third form is unsymmetrical, the optical characteristics thereof may be shown as anisotropy rather than isotropy. In detail, the effect of light scattering of one direction in which an inclined surface has a wider area is greater than that of the opposite direction. A better viewing angle may be provided by the opposite direction compared to the one direction. Accordingly, when the anisotropic optical characteristics are used, the luminance uniformity or the viewing angle of the display device 1000 can be improved.

Hereinafter, a fourth sample of various forms for the reflection pattern 2200 according to one embodiment of the present invention will be described.

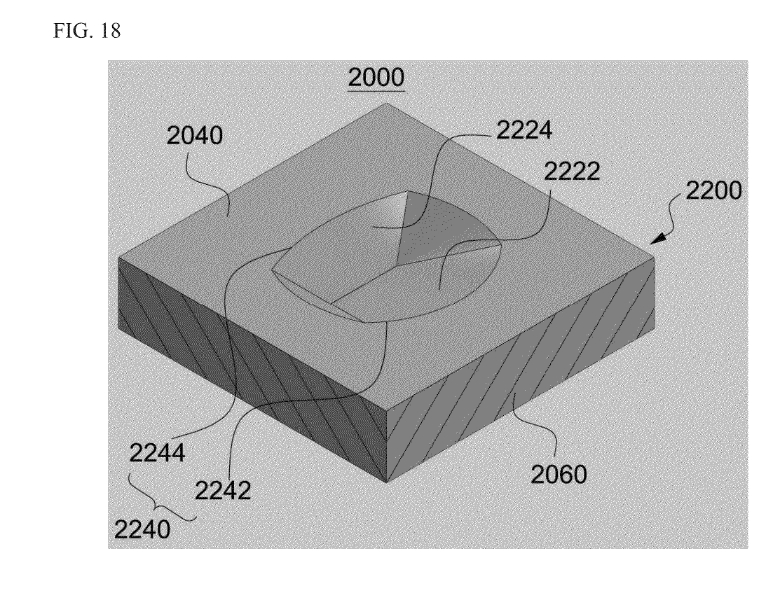

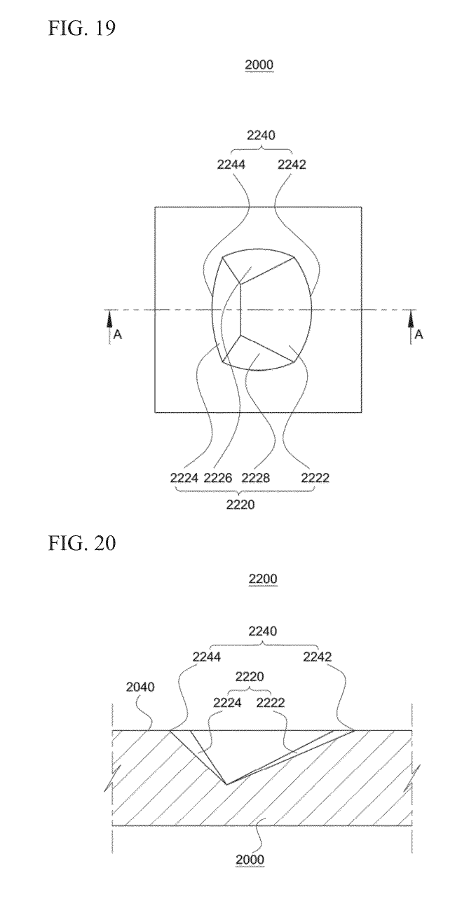

FIG. 18 is a perspective view of the fourth sample of the reflection pattern 2200 according to one embodiment of the present invention, FIG. 19 is a plan view of the fourth sample of the reflection pattern 2200 according to one embodiment of the present invention, and FIG. 20 is a cross-sectional view of the fourth sample of the reflection pattern 2200 according to one embodiment of the present invention.

Referring to FIGS. 18 to 20, a fourth form of the reflection pattern 2200 according to one embodiment of the present invention may include a concave portion 2220 and a boundary portion 2240 which surrounds the concave portion 2220. However, the boundary portion 2240 may include a first edge 2242 corresponding to a boundary in which the first inclined surface 2222 and the reflective surface 2040 are in contact with each other and a second edge 2244 corresponding to a boundary in which the second inclined surface 2224 and the reflective surface 2040 are in contact with each other in third form, but the boundary portion 2240 may include a third edge 2246 corresponding to a boundary in which the third inclined surface 2226 and the reflective surface 2040 are in contact with each other and a fourth edge 2248 corresponding to a boundary in which the fourth inclined surface 2228 and the reflective surface 2040 are in contact with each other in fourth form.

Since, in the reflection pattern 2200 having the fourth form, the shape of the concave portion 2220 may be entirely similar to the shape of the concave portion 2220 in the third form of the reflection pattern 2200, the description thereof will be omitted.

In the reflection pattern 2200 having the fourth form, the boundary portion 2240 may include a third edge 2246 and a fourth edge 2248 in which the third inclined surface 2226 and fourth inclined surface 2228 are in contact with the reflective surface 2040. The third edge 2246 and fourth edge 2248 may be formed in curved line shapes protruding to an outside of the concave portion 2220, a distance between the third edge 2246 and the fourth edge 2248 may be the greatest at the center of the concave portion 2220, and is decreased to both end portions of the concave portion 2220. At this time, the curvatures of the third edge 2246 and the fourth edge 2248 may be the same, or different.

Since the reflection pattern 2200 having the fourth form includes the third edge 2246 and the fourth edge 2248 bent compared to the reflection pattern 2200 having the third form, an area at which incident light arrives may be increased.

Accordingly, an amount of light scattered and diffused by the reflection pattern 2200 and emitted to the light output surface 2020 may be increased, and thus the luminance uniformity thereof can be greatly improved.

Further, since the shape of the reflection pattern 2200 having the fourth form is unsymmetrical, the optical characteristics thereof may be shown as anisotropy rather than isotropy. In detail, the effect of light scattering of one direction in which an inclined surface has a wider area is greater than that of the opposite direction. A better viewing angle may be provided by the opposite direction compared to the one direction. Accordingly, when the anisotropic optical characteristics are used, the luminance uniformity or the viewing angle of the display device 1000 can be improved.

Meanwhile, in the above description, it is described that the boundary portion 2240 having a greater curvature is formed on an inclined surface having a smaller slope angle, however, it is possible that the boundary portion 2240 having a smaller curvature is formed on an inclined surface having a greater slope angle if needed. Further, in the above description, it is described that an inclined surface having a smaller slope angle is disposed closer to the light incident surface 2060, but, it is possible that an inclined surface having a greater slope angle is disposed closer to the light incident surface 2060.

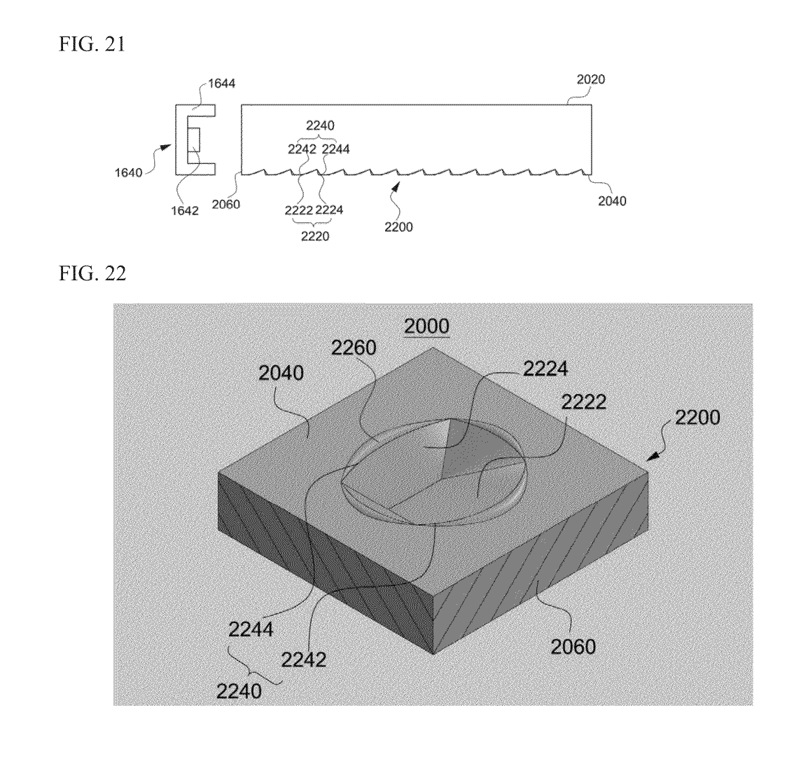

FIG. 21 is a cross-sectional view of a light guide plate 2000 having an unsymmetrical reflection pattern 2200 according to one embodiment of the present invention.

Referring to FIG. 21, in the concave portion 2220 of the reflection pattern 2200, an inclined surface which has a smaller slope angle and has an edge having a greater curvature may be disposed on the reflective surface 2040 in a direction closer to the light incident surface 2060. Generally, light moving to the reflection pattern 2200 is mainly moved from a direction of the light incident surface 2060, and thus, the gently inclined surface (the first inclined surface 2222) having a greater curvature in the concave portion 2220 is disposed in the above-described direction of incident light and effects of light diffusion and scattering of the widened concave portion 2220 can be maximized. Meanwhile, it is also possible that an inclined surface having a smaller slope angle is disposed far from the light incident surface 2060.

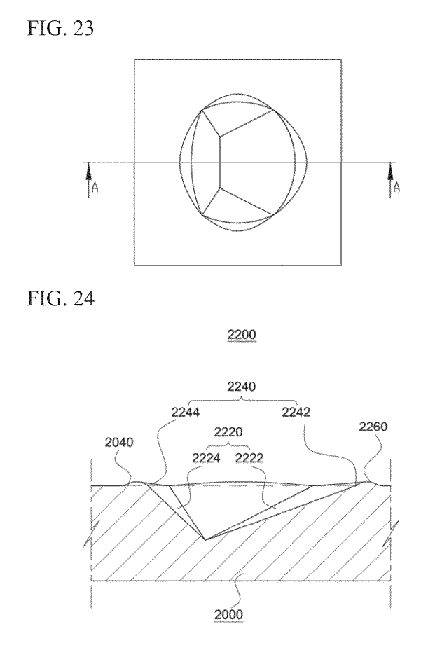

FIG. 22 is a perspective view of a fifth example of a reflection pattern according to one embodiment of the present invention, FIG. 23 is a plan view of the fifth example of the reflection pattern according to one embodiment of the present invention, and FIG. 23 is a cross-sectional view of the fifth example of the reflection pattern according to one embodiment of the present invention.

Referring to FIGS. 22 to 24, a fifth form of the reflection pattern 2200 according to one embodiment of the present invention may include a concave portion 2220, a boundary portion 2240 which surrounds the concave portion 2220, and embossed portions 2260. However, the embossed portions 2260 are not formed in the fourth form, but the embossed portions 2260 which protrude from the boundary portion 2240 in a direction opposite the light output surface 2020 may be included in the fifth form.

Since, in the reflection pattern 2200 having the fifth form, the shapes of the concave portion 2220 and the boundary portion 2240 may be entirely similar to those of the concave portion 2220 and the boundary portion 2240 in the fourth form of the reflection pattern 2200, the description thereof will be omitted.

The embossed portions 2260 may be formed by the boundary portion 2240 of the reflective surface 2040 protruding in a direction opposite the light output surface 2020. The embossed portions 2260 which protrude from a first edge 2242, a second edge 2244, a third edge 2246, and a fourth edge 2248 may have sizes and protruding heights which are the same or different. For example, the sizes and the protruding heights of a first and second embossed portions 2260 which protrude from the first edge 2242 and the second edge 2244 may be the same, the sizes and the protruding heights of the embossed portions 2260 which protrude from the third edge 2246 and the fourth edge 2248 may be the same, and the sizes and the protruding heights of the first and second embossed portions 2260 formed on the first edge 2242 and the second edge 2244 and the embossed portions 2260 formed on the third edge 2246 and the fourth edge 2248 may be different. Further, the areas and the heights of the first and second embossed portions 2260 formed on the first edge 2242 and the second edge 2244 may also be different. For example, among the first edge 2242 and the second edge 2244, a maximum height and area of the embossed portions 2260 formed on an edge having a smaller slope angle may be greater than those of the embossed portions 2260 formed on an edge having a greater slope angle, or also vice versa.

Since the shape of the reflection pattern 2200 having the fifth form is unsymmetrical, the optical characteristics thereof may be shown as anisotropy rather than isotropy. In detail, the effect of light scattering of one direction in which the thickness and the height of the embossed portions 2260 is greater than those of the opposite direction. Accordingly, the embossed portion 2260 having a greater height may be disposed closer to light incident surface, and the embossed portion 2260 having a smaller height may be disposed farther from the light incident surface, or also vice versa.

Further, a better viewing angle may be provided by the opposite direction compared to the one direction according to the maximum height and area of the embossed portions 2260. In detail, as the maximum height and area of the embossed portions 2260 are smaller, the viewing angle of the corresponding direction may be improved, accordingly, when the anisotropic optical characteristics are used, the luminance uniformity or the viewing angle of the display device 1000 can be improved.

Meanwhile, a lateral viewing angle is more important than a vertical viewing angle in the display device 1000, and thus, in the embossed portions 2260, a portion having a greater height and thickness may be vertically disposed to prevent the viewing angle from being degraded when the display device 1000 is watched. Furthermore, in a vertical viewing angle, according to which viewing angle between a downward viewing angle and an upward viewing angle is more important, a portion having the greater maximum height and thickness of the embossed portions 2260 may be disposed upward or downward with respect to the display device 1000. That is, since the maximum height and area of the embossed portions 2260 formed on the first edge 2242 and the second edge 2244 are greater than those of the embossed portions 2260 formed on the third edge 2246 and the fourth edge 2248, it may be advantageous that a direction from the first edge 2242 toward the second edge 2244 is vertical.

Further, according to a case, to be implemented for securing both of the luminance uniformity and the viewing angle of the display device 1000, the light source array 1640 is disposed in the downward direction and the reflection pattern 2200 is formed so that a portion having the greater embossed portion 2260 in the reflection pattern 2200 is disposed in the downward direction, and thus the securing of both the luminance uniformity and the viewing angle can be realized.

In the above-described reflection pattern 2200 according to one embodiment of the present invention, a length in a vertical direction (i.e., an absolute value of a height or depth) of the maximum depth of the concave portion 2220 may be the greatest, and that of the maximum height of the embossed portion 2260 may be the next greatest. In detail, the maximum depth of the concave portion 2220 may be in the range of approximately 20 to 100 μm, and the maximum height of the embossed portion 2260 may be in the range of approximately 0.5 to 10 μm. Further, when viewed in a direction perpendicular to the reflective surface 2040, the length in a longer direction in the concave portion 2220 may be in the range of approximately 20 to 150 μm, and the length in a shorter direction in the concave portion 2220 may be in the range of approximately 20 to 100 μm. However, the length in the longer direction in the concave portion 2220 may extend to the same length as the light incident surface 2060 of the light guide plate 2000 if needed. Further, the length in the shorter direction in the concave portion 2220 may also be greater than that of the example described above.

Meanwhile, the slope angle of the first inclined surface 2222 of the embossed portion 2260 may be in a range of 40 to 60°, and the slope angle of the second inclined surface 2224 may be in a range of 50 to 70°. Furthermore, the slope angles of the third inclined surface 2226 and the fourth inclined surface 2228 may be in a range of approximately 50 to 90°.

Further, the above drawings illustrate the reflection pattern 2200 having a smooth surface, but the reflection pattern 2200 may have a surface having a predetermined roughness, and particularly, the concave portion 2220 and the outer embossed portion 2260 may have a roughness having a predetermined value or more.

However, in the above descriptions, the specifications of the reflection pattern 2200 are not limited to the above-described height, depth, width, slope angle, roughness, etc., and it should be noted that they are suitably changeable if needed.

All of the reflection patterns 2200 formed on the reflective surface 2040 may be formed to have substantially the same specifications or different specifications of the reflection pattern 2200 based on portions of the reflective surface 2040 if needed. For example, when all of the reflection patterns 2200 are formed with the same specifications, there are advantages for manufacturing, and thus a production cost can be reduced. In the reverse case, when the diameter of the reflection pattern 2200 is adjusted to be smaller as the reflection pattern 2200 is closer to the light incident surface 2060, the luminance uniformity of the entire light output surface 2020 of the light guide plate 2000 can be improved.

The foregoing is illustrative of embodiments and is not to be construed as limiting thereof. Although a few embodiments have been described, those skilled in the art will readily appreciate that many modifications are possible in embodiments without materially departing from the novel teachings and advantages.

Accordingly, all such modifications are intended to be included within the scope of this inventive concept as defined in the claims.

### GLOSSARY

1000: display device
1600: back light unit
2000: light guide plate
2040: reflective surface
2060: light incident surface
2200: reflection pattern
2220: concave portion
2222: first inclined surface
2224: second inclined surface
2240: boundary portion
2242: first edge
2244: second edge
2260: embossed portion

What is claimed is:

1. A light guide plate comprising:
a light output surface configured to output light to the outside;
a reflective surface positioned opposite the light output surface;
a light incident surface provided on at least one side surface of side surfaces which connect the light output surface and the reflective surface, and configured to receive light emitted from a light source; and
a plurality of reflection patterns provided on the reflective surface,
wherein the reflection pattern includes a concave portion recessed in the reflective surface,
wherein the concave portion includes:
a first inclined surface which is formed to have a slope from the reflective surface toward the light output surface and has an edge which is in contact with the reflective surface and formed in a curved line; and
a second inclined surface which is formed to have a slope from the first inclined surface toward the reflective surface and has an edge which is in contact with the reflective surface and formed in a curved line.

2. The light guide plate of claim 1, wherein:
when viewed in a direction perpendicular to the reflective surface, the reflection pattern has a rectangular shape; and
the edges of the first inclined surface and the second inclined surface have curved line shapes protruding to an outside of the rectangular shape.

3. The light guide plate of claim 1, wherein a curvature of the edge of the first inclined surface and a curvature of the edge of the second inclined surface are different.

4. The light guide plate of claim 3, wherein one of the first and second inclined surfaces which is closer to the light incident surface has an edge having a greater curvature than the other.

5. The light guide plate of claim 3, wherein one of the first and second inclined surfaces which has the greater curvature has a smaller slope angle than the other.

6. The light guide plate of claim 5, wherein the one having the smaller slope angle between the first inclined surface and the second inclined surface is disposed closer to the light incident surface than the other.

7. The light guide plate of claim 6, wherein:
the one having the smaller slope angle between the first and second inclined surfaces has a slope angle in a range of 40 to 60°; and
the other having the greater slope angle among the first and second inclined surfaces has a slope angle in a range of 50 to 75°.

8. The light guide plate of claim 1, wherein:
the reflection pattern further includes a pair of side surfaces recessed from the reflective surface and formed on both sides of each of the first inclined surface and the second inclined surface; and
an edge at which each of the side surfaces and the reflective surface are in contact with each other has a straight line shape.

9. The light guide plate of claim 1, wherein:
the reflection pattern further includes a pair of side surfaces formed on both sides of each of the first inclined surface and the second inclined surface and having slopes from the reflective surface toward the light output surface; and
an edge at which each of the side surfaces and the reflective surface are in contact with each other has a curved line shape.

10. The light guide plate of claim 9, wherein a curvature of the edge at which the side surface and the reflective surface are in contact each other is smaller than those of the edge at which the first inclined surface and the reflective surface are in contact with each other and the edge at which the second inclined surface and the reflective surface are in contact each other.

11. The light guide plate of claim 1, wherein the reflection pattern further includes a first embossed portion which is formed on an edge of the first inclined surface and protrudes from the reflective surface.

12. The light guide plate of claim 11, wherein the reflection pattern further includes a second embossed portion which is formed on an edge of the second inclined surface and protrudes from the reflective surface.

13. The light guide plate of claim 12, wherein:
a maximum height of the first embossed portion is greater than that of the second embossed portion; and
when viewed in a direction perpendicular to the reflective surface, an area of the first embossed portion is greater than that of the second embossed portion.

14. A back light unit comprising:
a light source configured to emit light; and
a light guide plate,
wherein the light guide plate includes:
a light incident surface which faces the light source and receives incident light emitted from the light source;
a light output surface which is perpendicular to the light incident surface and configured to output incident light to the outside;
a reflective surface which is a surface opposite the light output surface; and
a plurality of reflection patterns provided on the reflective surface to be parallel to the light incident surface,
wherein each of the reflection patterns includes a concave portion recessed in the reflective surface,
wherein the concave portion includes:
a first inclined surface which is formed to have a slope from the reflective surface toward the light output surface and has an edge which is in contact with the reflective surface and formed in a curved line; and
a second inclined surface which is formed to have a slope from the first inclined surface toward the reflective surface, and has an edge which is in contact with the reflective surface and formed in a curved line.

15. The light guide plate of claim 14, wherein:
when viewed in a direction perpendicular to the reflective surface, the reflection pattern has a rectangular shape; and
edges of the first inclined surface and the second inclined surface have curved line shapes protruding to an outside of the rectangular shape.

16. The light guide plate of claim 14, wherein a curvature of the first inclined surface and a curvature of the second inclined surface are different.

17. The light guide plate of claim 16, wherein an edge of one of the first and second inclined surfaces which is closer to the light incident surface has a greater curvature than the other.

18. The light guide plate of claim 17, wherein the one having the greater curvature between the first inclined surface and the second inclined surface has a smaller slope angle than the other.

19. The light guide plate of claim 18, wherein the one having the smaller slope angle between the first inclined surface and the second inclined surface is disposed closer to the light incident surface.

20. The light guide plate of claim 14, wherein the reflection pattern further includes:
a first embossed portion which is formed on an edge of the first inclined surface and protrudes from the reflective surface; and
a second embossed portion which is formed on an edge of the second inclined surface and protrudes from the reflective surface.
